(19) United States
(12) Patent Application Publication
(10) Pub. No.: US 2025/0088527 A1
(43) Pub. Date: Mar. 13, 2025

(54) Systems and Methods for Use of Identity Graphs to Create an Application Security Layer

(71) Applicant: SpecTrust, Inc., San Jose, CA (US)

(72) Inventors: Nate Kharrl, San Jose, CA (US); Colben Matthew Kharrl, Goodyear, AZ (US)

(21) Appl. No.: 18/963,329

(22) Filed: Nov. 27, 2024

Related U.S. Application Data
(63) Continuation-in-part of application No. 17/564,014, filed on Dec. 28, 2021.

(51) Int. Cl. H04L 9/40

(52) U.S. Cl. CPC H04L 63/1433

(57) ABSTRACT

Exemplary embodiments include a system configured by at least one processor to execute instructions stored in memory to form a protective layer between an application and a cybersecurity risk, the system comprising an HTTPS load balancer in communication with a controller/proxy, the controller/proxy configured to detect user data contained in one or more user requests, create a copy of the user data, and index the session to which the user data is associated; a customer database in communication with the controller/proxy, the customer database comprised of one or more identity graphs, each of the one or more identity graphs comprised of an index identity item and one or more related data items; and a session database in communication with the controller/proxy and the customer database, the session database configured to collate, write, and store session information from one or more sessions to each of the one or more identity graphs.

### CROSS-REFERENCE TO RELATED APPLICATIONS

The present U.S. patent application is a Continuation in Part and claims the benefit of the previous U.S. Patent Application entitled “Systems, Methods and Media for the Creation of a Protective Layer Between an Application and a Cybersecurity Risk” filed on Dec. 28, 2021, having Ser. No. 17/564,014, which is incorporated by reference in its entirety, including all appendices.

### FIELD OF INVENTION

The present technology pertains to systems, methods, and media for network security.

### SUMMARY OF EXEMPLAY EMBODIMENTS

Exemplary embodiments include a system configured by at least one processor to execute instructions stored in memory to form a protective layer between an application and a cybersecurity risk, the system comprising an HTTPS load balancer in communication with a controller/proxy, the controller/proxy configured to detect user data contained in one or more user requests, create a copy of the user data, and index the session to which the user data is associated; a customer database in communication with the controller/proxy, the customer database comprised of one or more identity graphs, each of the one or more identity graphs comprised of an index identity item and one or more related data items; and a session database in communication with the controller/proxy and the customer database, the session database configured to collate, write, and store session information from one or more sessions to each of the one or more identity graphs.

In some embodiments, a first identity graph of the one or more identity graphs is indexed by a first item of related identity data, and the first identity graph comprises the first item of related identity data and one or more subsequent items of related identity data.

In some embodiments, the controller/proxy is configured to attribute the one or more requests to a specific end-user by: generating one or more technical fingerprints using probabilistic matching of common message characteristics and device and network attributes in the concurrent, unordered, and unsigned requests; and using the one or more technical fingerprints with a fuzzy matching algorithm to compare a first received request to a second received request. In some such embodiments, the one or more technical fingerprints are generated from any of the following: http header information, Transmission Control Protocol (TCP) window size, size of window expansion, time-out time, and maximum window size. The one or more technical fingerprints are used to generate an identifier and the identifier is used as a first request in a new session.

In some embodiments, the controller/proxy is in communication with a secrets management server and a workflow engine, and the workflow engine is in communication with the session database, the secrets management server and an integration station. The controller/proxy is configured to write secrets to the secrets management server, and the workflow engine configured to read secrets from the secrets management server.

The HTTPS load balancer may be configured to perform load balancing and autoscaling of communications to the controller/proxy. The controller/proxy may be configured to write session data to the session database, and the controller/proxy may be configured to read secrets to the secrets management server.

Additionally, the controller/proxy may be configured to forward a request to a customer origin server. The workflow engine may be configured to read secrets from the secrets management server, and the workflow engine may be configured to read/write session data, workflow data, and integration data to the session database. The workflow engine can be configured to cause the integration station to trigger a third-party call, and the integration station can be configured to trigger vendor integration with an external risk vendor. Further, the integration station can be configured to trigger customer integration with a customer endpoint server.

In various exemplary embodiments, the hub server may be configured to read session data and read and write customer configuration data and investigation data to the session database. The hub server may be configured to read and write a secret to the secrets management server and the hub server may be configured to serve the hub client as a static asset to a customer computing device. Additionally, the session database may be configured to store collated session information. The secrets management server may be configured to store a secret and other sensitive information. The hub client may be configured as a static front-end asset.

The intelligent secure networked system, according to exemplary embodiments, may perform passive traffic monitoring in parallel and process risk information in under 20 milliseconds. Additionally, the intelligent secure networked system may be Service Organization Control (SOC) 2 security audit compliant.

In various exemplary embodiments, a networked user computing device may be in communication with the HTTPS load balancer, and a customer origin server may be in communication with the controller/proxy. An external risk vendor server may be in communication with the integration station. The architecture may also include a customer endpoint server and an external risk vendor server.

Additionally, the collated session information, in many exemplary embodiments, may include concurrent, unordered and unsigned requests that are positively attributed to a device of a specific end-user. Device and network attributes may be used in the concurrent, unordered and unsigned requests to generate a technical fingerprint. A technical fingerprint with a fuzzy matching algorithm may be used to compare a request to another received request to attribute it to the device of the specific end-user. The customer configuration data may provide configuration instructions to any of a spec proxy, the workflow engine or the integration station. The customer configuration data may be deployed in the hub server.

Exemplary methods include using an intelligent secure networked system configured by at least one processor to execute instructions stored in memory to form a protective layer between an application and a cybersecurity risk, the method including a HTTPS load balancer communicating with a controller/proxy, the controller/proxy communicating with a session database, a secrets management server and a workflow engine, the workflow engine communicating with the session database, the secrets management server and an integration station, and a hub server communicating with the session database, the secrets management server, and a hub client. The HTTPS load balancer may perform load balancing and autoscaling of communications to the controller/proxy. The controller/proxy may write session data to the session database and the controller/proxy may read secrets to the secrets management server. Further, the controller/proxy may forward a request to a customer origin server.

The workflow engine, according to exemplary embodiments, may read secrets from the secrets management server and the workflow engine may read and write session data, workflow data, and integration data to the session database. The workflow engine may cause the integration station to trigger a third-party call. The integration station may trigger vendor integration with an external risk vendor. The integration station may also trigger customer integration with a customer endpoint server.

According to various exemplary embodiments, the hub server may read session data and read and write customer configuration data and investigation data to the session database. The hub server may read and write a secret to the secrets management server. The hub server may serve the hub client as a static asset to a customer computing device. The session database may also store collated session information. The secrets management server may store a secret and other sensitive information. The hub client may serve as a static front-end asset.

Exemplary methods also include performing passive traffic monitoring in parallel and processing risk information in under 20 milliseconds. The intelligent secure networked system may be Service Organization Control (SOC) 2 security audit compliant, and a networked user computing device may communicate with the HTTPS load balancer. Additionally, a customer origin server may communicate with the controller/proxy and an external risk vendor server may communicate with the integration station. Additional methods may include a customer endpoint server and an external risk vendor server.

Collated session information, according to exemplary methods, may include concurrent, unordered and unsigned requests that are positively attributed to a device of a specific end-user. Device and network attributes may be used in the concurrent, unordered and unsigned requests to generate a technical fingerprint. The technical fingerprint may be used with a fuzzy matching algorithm to compare a request to another received request to attribute it to the device of the specific end-user. The customer configuration data may provide configuration instructions to any of a spec proxy, the workflow engine or the integration station. Additionally, the customer configuration data may be deployed in the hub server.

In addition to the system, further disclosed herein are the method of using the system to create a security layer, as well as the method of assembling the system by configuring, programming, and communicatively coupling its various components.

### BRIEF DESCRIPTION OF THE DRAWINGS

Certain embodiments of the present technology are illustrated by the accompanying figures. It will be understood that the figures are not necessarily to scale. It will be understood that the technology is not necessarily limited to the particular embodiments illustrated herein.

FIG. 1 is an exemplary architecture for an intelligent secure networked system to form a protective layer between an application and a cybersecurity risk.

FIG. 2 illustrates an exemplary session collation schematic.

FIG. 3 illustrates an exemplary data structure for session collation according to exemplary embodiments.

### DETAILED DESCRIPTION

The detailed embodiments of the present technology are disclosed here. It should be understood that the disclosed embodiments are merely exemplary of the technology, which may be embodied in multiple forms. Those details disclosed herein are not to be interpreted in any form as limiting, but as the basis for the claims.

In the description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

Exemplary embodiments of the present technology include a dedicated database having a data structure and storage scheme that enables an operator, such as a network security service, to read and write identity data at scale. In some embodiments, the identity data is available for real time analytics and model processing. According to these embodiments, the entire networked history of any single identity datum and its relation to other identity data through different events and operations. Network security service is thereby enabled to rapidly answer questions regarding user behavior and relational linking between identity data points over vast amounts of data.

In an exemplary method, network traffic, such as one or more user requests in real time Internet traffic, are detected by a controller/proxy. The controller/proxy creates a copy of user identity data and identifies a session to which the user is associated. The identity data for any given event is detected by the controller/proxy and recorded to the dedicated database. According to the data structure of the database, each item of identity data has its own identity graph, or “book”, and each “book” includes relational links to associated identity data stored in other books.

In an exemplary embodiment, a given customer for a network security service may have tens of millions of customer journeys per month. Each customer journey may have thousands or tens of thousands of events, and each event will have identity data associated with it. As used herein, “identity data” refers to any data that has an identity-linking characteristic with something or someone in the physical world. Examples of identity data include email address, IP address, identification number, social security number, or username. If one such identifier appears on more than one event, the events are linked by the association of the same identifier.

In one example, if a user tries to make a payment on a customer site, the network security service would see the customer's name, address, phone number, and credit card. An identity graph, or book, is generated for each of these data entries and includes each of the related items. A book is generated for the customer's name and includes the customer's address, phone number, and credit card; a book is also generated for the customer's address and includes the customer's name, phone number, and credit card—and so on for each item of identity data.

In some embodiments, preexisting records are stored for one or more of these identifiers and the event detail is added to all preexisting records.

The security service is enabled to read from and write to each book, or identity graph. A network of identity graphs is constructed to represent the journeys and events as they relate to one another. Inferences can be drawn regarding patterns in these journeys and events, such as unusual credit card activity and other suspicious or potentially high-risk actions.

If suspicious or malicious activity is detected, the system addresses the threat in one or more ways according to the threat level and nature of the threat. In some embodiments, the system “tags” or “labels” either the session or identity data that are part of the session. This tracks the data or session and enables the system to monitor the activity for further suspicious behavior. In some embodiments, notifications and web hooks are pushed out to other systems. For example, a message is pushed to investigations or incident group or enterprise resource planning (ERP) system. The message may include a notice to freeze an account, verify identity, or delay shipment, among other examples.

In some embodiments, active measures are taken against suspicious or malicious network activity. Active measures include blocking, such as pushing back an error message and prevent activity from going through the network; redirecting, such as sending a user deemed suspicious to an alternative experience, such as a step-up paradigm where a user must validate that they are the person they purport to be; and obfuscation, or intentional confusion of an actor deemed malicious. Obfuscation may include a false checkout page or an online experience that diverts the malicious actor from completing an operation on the customer's system.

In some embodiments, the system further includes an analytics database, which stores information regarding the system's categorization of events as malicious or suspicious. The analytics database enables investigators and analysts to review system classifications and the data on which the classifications were based.

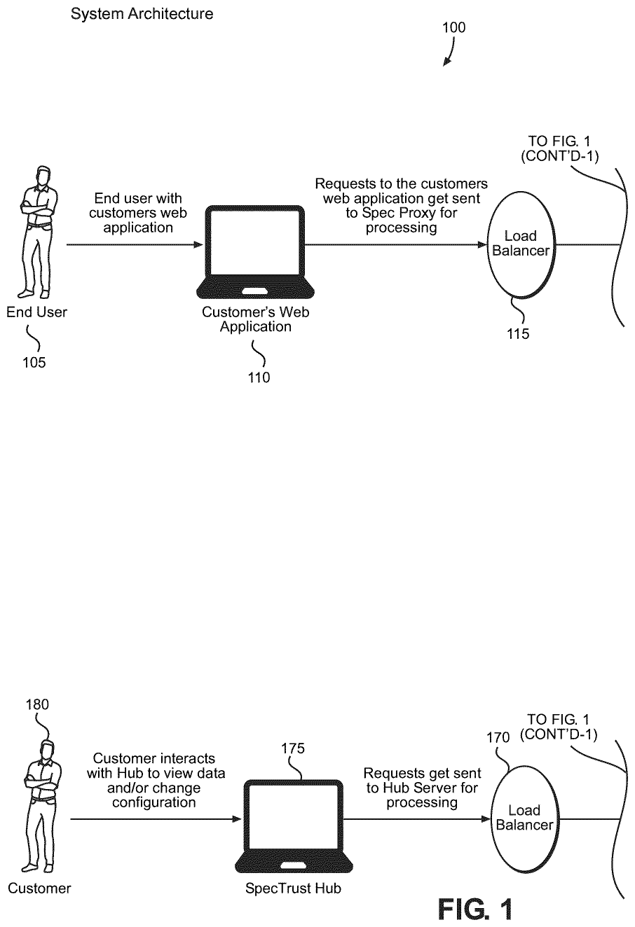

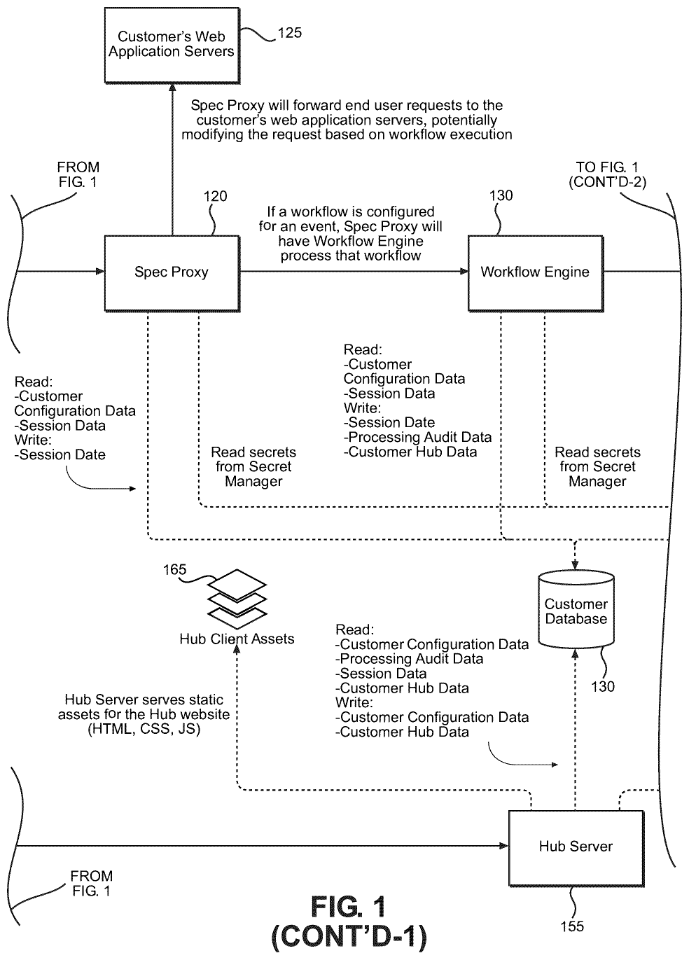

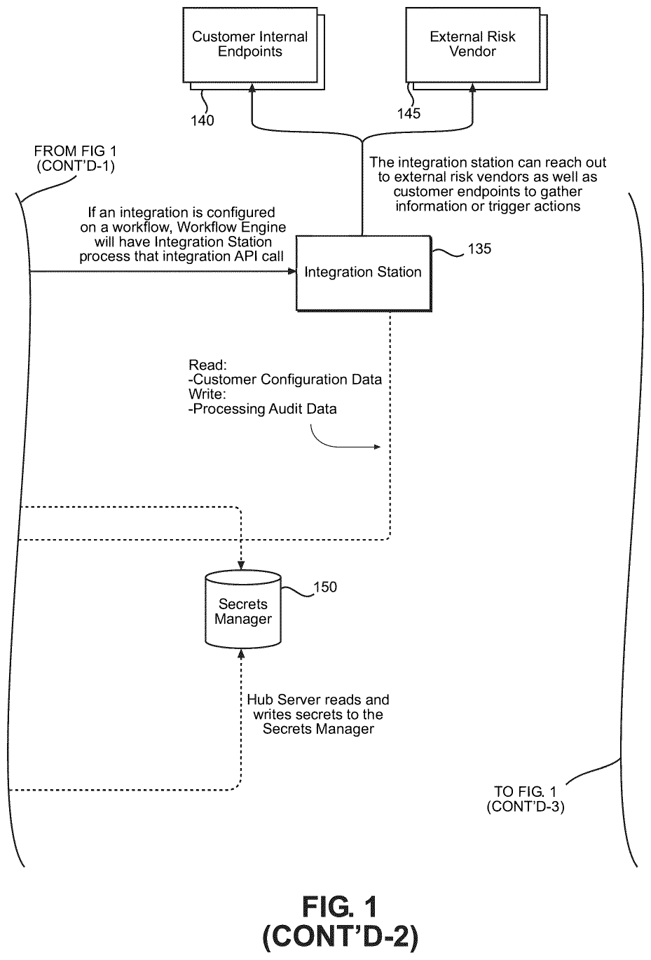

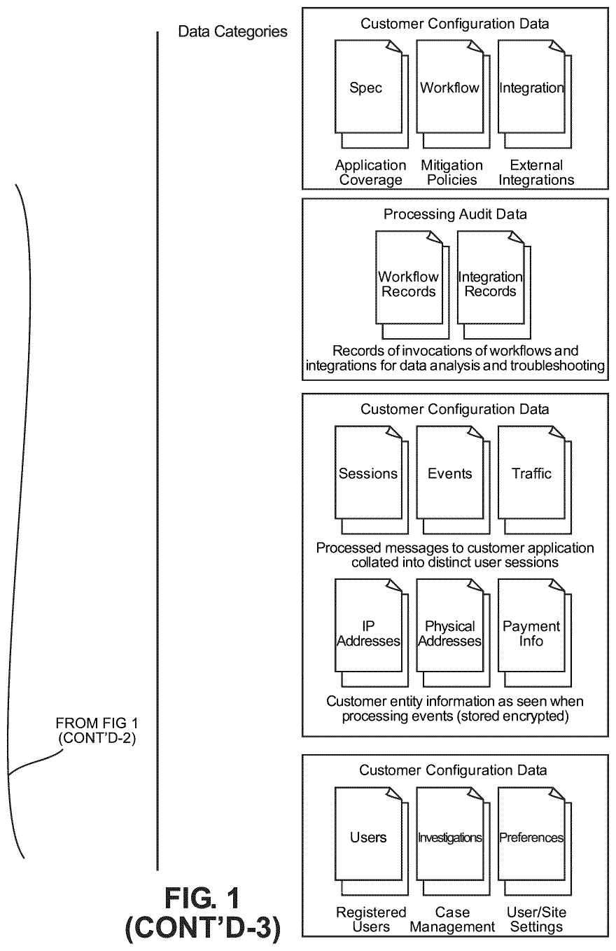

FIG. 1 describes a system that extracts, processes, and stores data pursuant to detecting cybercrime access patterns from real-time traffic flowing to and from a commercial software application. Processing instructions for external data enrichment and automated workflow execution can be streamed to this platform in real time to dynamically adjust its operation. All data processed by the platform is stored as an operation record that provides context for future processing.

According to exemplary embodiments, an end-user interacts with an online application using their mobile device or web browser. That request is routed to the platform via a domain route setting. An application load balancer selects an available spec proxy to handle the request. The selected spec proxy determines if the request needs to be processed, and if so, if the request should be held until processing is complete. These instructions are stored in the secrets management system. If the request is to be processed, the spec proxy detects relevant user data contained in the request and creates a copy of that data, normalizes it for the platform's data structure, and determines what user session to associate this data with. If this request should trigger workflows (as configured in the secrets management system), the workflow engine transforms data into workable facts, evaluates facts against conditional criteria, and queries external systems through the integration station. The result of the workflow engine's execution could be to trigger actions that would alter the original request, send requests to downstream systems and/or update risk assessments in the associated user session record.

The original request is serviced by spec proxy, either by forwarding it to the intended application origin or responding directly to the end user. Stakeholders for the online application can review a full record of the session on the hub, which can access and analyze the data created by the spec proxies, workflow engines, and integration stations. The hub can also change configurations stored in the secrets management system.

In greater detail, FIG. 1 is an exemplary architecture 100 for an intelligent secure networked system to form a protective layer between an application and a cybersecurity risk.

Shown in FIG. 1 are end user 105, customer's web application 110, load balancer 115, spec proxy 120, customer's web application servers 125, workflow engine 130, integration station 135, customer internal endpoints 140, external risk vendor 145, secrets manager 150, hub server 155, customer database 160, hub client assets 165, load balancer 170, spec trust hub 175, and customer 180.

According to exemplary embodiments, the end user 105 interacts with customer's web application 110. Requests to the customers web application are sent to spec proxy 120 for processing. These requests are sent via load balancer 115. Spec proxy 120 forwards end user requests to the customer's web application servers 125, potentially modifying the request based on the workflow execution. If a workflow is configured for an event, spec proxy 120 will have the workflow engine 130 process that workflow. Spec proxy 120 is configured to read customer configuration data, session data, and to write session date. Spec proxy 120 is also configured to read secrets from the secret manager 150. The workflow engine 130 is configured to read customer configuration data, and session data. The workflow engine 130 is also configured to write session date, processing audit date, and customer hub data. The workflow engine 130 is also configured to read secrets from the secret manager 150. If an integration is configured on a workflow, workflow engine 130 will have integration station 135 process that integration API call. Integration station 135 can reach out to external risk vendor 145 and customer internal endpoints 140 to gather information or trigger actions. The integration station 135 is configured to read customer configuration data and to write processing audit data. The hub server 155 reads and writes secrets to the secrets manager 150.

The customer database 160 is configured to receive from the hub server 155 customer configuration data, process audit data, session data, and customer hub data. The customer database 160 is also configured to receive customer configuration data and customer hub data. The hub server 155 serves static assets for the hub website as received at hub client assets 165.

As shown in FIG. 1, customer 180 interacts with the spec trust hub 175 to view data and or change configurations on spec trust hub 175. Requests from spec trust hub 175 are sent to the hub server 155 for processing by way of load balancer 170.

Also shown in FIG. 1 are data categories including customer configuration data, processing audit data, customer configuration data, and customer configuration data. The customer configuration data includes spec, workflow, and integration data. The spec data includes application coverage, the workflow data includes mitigation policies, the integration data includes external integrations. The processing audit data includes workflow records and integration records. The processing audit data includes records of invocations of workflows and integrations for data analysis and troubleshooting. Customer configuration data includes sessions, events, and traffic. The customer configuration data includes processed messages to customer applications collated into distinct user sessions. The customer configuration data also includes IP addresses, physical addresses, and payment information. The customer configuration data includes customer entity information as seen when processing events and is stored encrypted. The customer configuration data includes users, investigations and preferences. This also includes registered users, case management, and user/site settings.

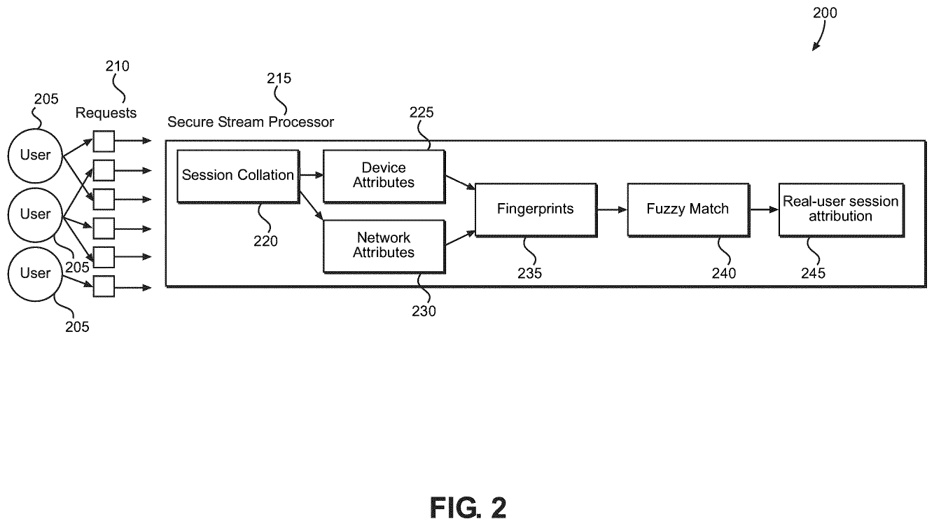

FIG. 2 illustrates an exemplary session collation schematic 200.

FIG. 2 describes a system that determines common request owners in a large stream of mixed network requests, some of which may be users that are intentionally trying to disguise their identity, by using probabilistic matching of common message characteristics.

Schematic 200 shows a plurality of users 205, a plurality of requests 210, secure stream processor 215, session collation 220, device attributes 225, network attributes 230, fingerprints 235, fuzzy match 240, and real user session attribution 245.

As shown in FIG. 2, multiple users 205 are associated with multiple requests 210 going into a secure stream processor 215. Within the secure stream processor 215, session collation 220 is communicated to device attributes 225 and network attributes 230, both of which are communicated to fingerprints 235, which are communicated to fuzzy matching 240, which are communicated to real-user attribution 245.

In some embodiments, “fuzzy matching” includes taking a time sequence for a given request including any information identifiable in the request, such as http header and Transmission Control Protocol (TCP) window information (congestion window), including the window's initial size, size of expansion, time-out time, and maximum window size as configured by the device. The request information is used to create internal anchors, which in some embodiments are comprised of three “fingerprints”. The system searches active sessions for any of these fingerprints.

According to exemplary embodiments, spec proxies process multiple requests without explicit knowledge to which end user each request comes from. Each spec proxy generates unique cryptographic fingerprints for each request using network data and system data contained within each request. A fingerprint-matching algorithm ensures that each request is associated with prior requests based on common fingerprints.

If any fingerprints are present in the active sessions, a match is noted, and the process is carried forward. If no match is detected in the active sessions, the fingerprints are used to cryptographically generate an identifier and the identifier is used as a first request in a new session. It should be noted that the identifier is generated cryptographically in case multiple requests can be matched at the same time, or during the same session. It is thus possible for more than one request to resolve to the same identifier.

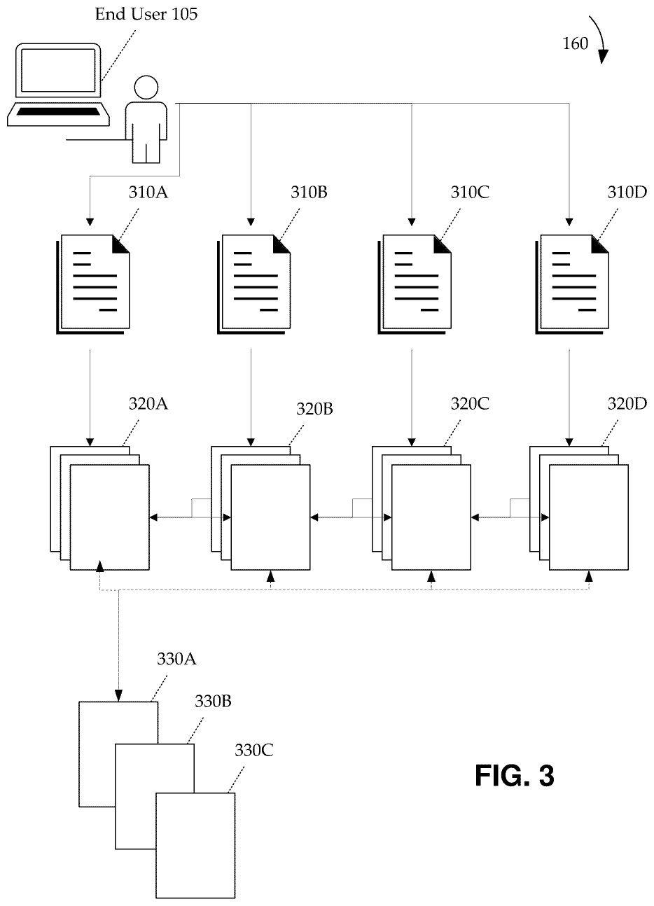

FIG. 3 illustrates an exemplary data structure for session collation according to exemplary embodiments. According to the embodiment shown in FIG. 3, identity data associated with an end user 105 is stored in the customer database 160. The customer database 160 is comprised of a plurality of identity graphs 310A-D, each of which is comprised of one or more items of related identity data 320A-D. The customer database is communicatively coupled to the spec proxy 120, which is configured to write session data 330A-C to each of the plurality of identity graphs 310A-D.

Each identity graph 310A-D stores and indexes related identity data in parallel with each other identity graph 310A-D to ensure rapid read and write. Each identity graph 310A- D is indexed by a first item of identity data and is comprised of the first item and of one or more subsequent items of related identity data. A first identity graph 310A will be indexed by a first related item of identity data 320A and include subsequent items 320B-D, and a second identity graph 310B will be indexed by a second item 320B and will include subsequent items 320A 320C 320D, which may in turn include the first item 320A that is used to index the first identity graph 310A.

By way of example, if the customer of the network security service is an online shop, a user may be an online shopper. In this example, a first identity graph 310A is be generated for all information related to a user's email address. Related user information 320A includes details such as the user's full name as entered, mailing address, and credit card information. A second identity graph 310B is generated for the user's full name as entered, and related user information 320B includes the user's email address, mailing address, and credit card information. Subsequent identity graphs 310C-D are generated and indexed for each item of identity data associated with the user, each having related user information 320C-D associated with the indexed item of identity data. These listings for identity graphs 310A-D and related user data 320A-D are exemplary and not limiting by quantity or type.

Spec proxy 120 is configured to read customer configuration data, session data 330A-C, and to write session data 330A-C to each identity graph 310A-D. A session associated with a given email address will result in session data being written to any identity graph that includes that email address. Using this data structure, no matter what identity data the servicer starts with, they are enabled to find other pieces of identity data with which the first identity data has commonality, as well as historical behavior associated with any one of these identity data.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

While various embodiments have been described above, it should be understood that they have been presented by way of example only, and not limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A system configured by at least one processor to execute instructions stored in memory to form a protective layer between an application and a cybersecurity risk, the system comprising:
an HTTPS load balancer in communication with a controller/proxy, the controller/proxy configured to detect user data contained in one or more user requests, create a copy of the user data, and index the session to which the user data is associated;
a customer database in communication with the controller/proxy, the customer database comprised of one or more identity graphs, each of the one or more identity graphs comprised of an index identity item and one or more related data items; and
a session database in communication with the controller/proxy and the customer database, the session database configured to collate, write, and store session information from one or more sessions to each of the one or more identity graphs.

2. The system of claim 1, wherein a first identity graph of the one or more identity graphs is indexed by a first item of related identity data, and the first identity graph comprises the first item of related identity data and one or more subsequent items of related identity data.

3. The system of claim 1, the session information further comprising requests that are received concurrently, unordered, or in unsigned form and subsequently collated by the system and attributed to a device of a specific end-user.

4. The system of claim 1, the controller/proxy being configured to attribute the one or more requests to a specific end-user by:
generating one or more technical fingerprints using probabilistic matching of common message characteristics and device and network attributes in the concurrent, unordered, and unsigned requests; and
using the one or more technical fingerprints with a fuzzy matching algorithm to compare a first received request to a second received request.

5. The system of claim 4, the one or more technical fingerprints being further generated from any of the following: http header information, Transmission Control Protocol (TCP) window size, size of window expansion, time-out time, and maximum window size.

6. The system of claim 4, wherein the one or more technical fingerprints are used to generate an identifier and the identifier is used as a first request in a new session.

7. The system of claim 1, further comprising the controller/proxy being in communication with a secrets management server and a workflow engine and the workflow engine being in communication with the session database, the secrets management server and an integration station.

8. The system of claim 7, further comprising the controller/proxy configured to write secrets to the secrets management server.

9. The system of claim 7, further comprising the workflow engine configured to read secrets from the secrets management server.

10. A method executable at least one processor executing instructions stored in memory to form a protective layer between an application and a cybersecurity risk, the method comprising:
detecting user data contained in one or more user requests, the detecting executed by controller/proxy in communication with an HTTPS load balancer;
creating a copy of the user data and indexing the session to which the user data is associated;
storing the copy of the user data to a customer database in communication with the controller/proxy, the customer database comprised of one or more identity graphs, each of the one or more identity graphs comprised of an index identity item and one or more related data items; and
collating, writing, and storing session information from one or more sessions to each of the one or more identity graphs by a session database in communication with the controller/proxy and the customer database.

11. The method of claim 10, wherein a first identity graph of the one or more identity graphs is indexed by a first item of related identity data, and the first identity graph comprises the first item of related identity data and one or more subsequent items of related identity data.

12. The method of claim 10, the session information further comprising requests that are received concurrently, unordered, or in unsigned form and subsequently collated by the system and attributed to a device of a specific end-user.

13. The method of claim 10, the controller/proxy being configured to attribute the one or more requests to a specific end-user by:
generating one or more technical fingerprints using probabilistic matching of common message characteristics and device and network attributes in the concurrent, unordered, and unsigned requests; and
using the one or more technical fingerprints with a fuzzy matching algorithm to compare a first received request to a second received request.

14. The method of claim 13, the one or more technical fingerprints being further generated from any of the following: http header information, Transmission Control Protocol (TCP) window size, size of window expansion, time-out time, and maximum window size.

15. The method of claim 13, wherein the one or more technical fingerprints are used to generate an identifier and the identifier is used as a first request in a new session.

16. The method of claim 10, further comprising the controller/proxy being in communication with a secrets management server and a workflow engine and the workflow engine being in communication with the session database, the secrets management server and an integration station.

17. The method of claim 16, further comprising the controller/proxy configured to write secrets to the secrets management server.

18. The method of claim 16, further comprising the workflow engine configured to read secrets from the secrets management server.

19. A method of assembling a networked system configured by at least one processor to execute instructions stored in memory to form a protective layer between an application and a cybersecurity risk, the method comprising:
communicatively coupling an HTTPS load balancer to a controller/proxy, the controller/proxy configured to detect user data contained in one or more user requests, create a copy of the user data, and index the session to which the user data is associated;
communicatively coupling a customer database to the controller/proxy, the customer database comprised of one or more identity graphs, each of the one or more identity graphs comprised of an index identity item and one or more related data items; and
communicatively coupling a session database to the controller/proxy and the customer database, the session database configured to collate, write, and store session information from one or more sessions to each of the one or more identity graphs.

20. The method of claim 19, wherein a first identity graph of the one or more identity graphs is indexed by a first item of related identity data, and the first identity graph comprises the first item of related identity data and one or more subsequent items of related identity data.
